(19) United States
(12) Patent Application Publication
(10) Pub. No.: US 2009/0171735 A1
(43) Pub. Date: Jul. 2, 2009

(54) AUTOMATED KITTING FOR SHORT BUILD MANUFACTURING

(75) Inventors: Sonia J. Cushing, Rochester, MN (US); Eric M. Jones, Rochester, MN (US); Ivory W. Knipfer, Rochester, MN (US); Matthew H. Zemke, Rochester, MN (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/967,822

(22) Filed: Dec. 31, 2007

(51) Int. Cl. G06Q 10/00; G06F 17/00

(52) U.S. Cl. 705/8

(57) ABSTRACT

A method for managing production of a product when components of the product are missing during a manufacturing process is provided. The method includes applying a first set of rules for determining whether a short work unit can be released for manufacturing and clearing the short work unit to build. The method further includes allocating for manufacturing components of the short work unit present in inventory and storing a record including a list of short components. The method further includes generating a first kit and storing a record including a location of the first kit. The method further includes initiating manufacturing of the first kit and determining that at least one of the short components of the short work unit are present in inventory. The method further includes generating a second kit for the short components of the short work unit that are present in inventory.

### BACKGROUND OF THE INVENTION

1. Field of the Invention

The present invention relates to commercial manufacturing processes, and more particularly to management of short work units for commercial manufacturing processes.

2. Description of the Related Art

Manufacturers today must strike a balance between ever increasing pressures to deliver products on time and carrying excessive and costly inventory in the supply network. This balance can be difficult to maintain when supply problems occur, such as shortages in materials, quality fallout, or unforeseen economic conditions in trade and transportation, which can result in supply interruptions.

A work unit may go through various routings before becoming a final product. A work unit refers to an incomplete product undergoing manufacturing wherein the work unit may refer to one part of a larger whole. Before starting the manufacturing of a product, a “clear to build” process is executed wherein the current inventory is checked for the necessary parts. If the necessary parts for a product are present in the inventory, then the manufacturing process is “clear to build” the product.

Current customer expectations, however, are such that it is no longer feasible to wait for all materials to arrive before manufacturing proceeds to build the customer products. Thus, at times it is beneficial to start the manufacturing of the product of an incoming order before all of the necessary parts are available. This type of work unit is called a short work unit because it is short at least one component or part. A missing component or part is called a short component or a short part.

The conventional approach to this problem involves starting manufacturing of a short work unit insofar as manufacturing can be performed without the short component. When the short work unit has been manufactured as much as possible, the work unit is halted in the manufacturing process as it waits for the arrival of the short component. The conventional approach, however, does not provide an automated method for managing the appropriate allocation of short parts as they become available.

Further, the conventional approach stops all work in progress on a work unit at the exact location and time when the halt is issued. The above approach does not allow for strategic start and stop of manufacturing at future positions in the manufacturing process. This prevents manufacturing from completing as much of the process as possible for the given circumstances, thereby jeopardizing customer shipments and company revenue. Further, the conventional solution operates at a work unit level rather than discrete work unit component levels. Consequently, when manufacturing starts, all sub-work units (or component kits) associated with the primary work unit start also.

Another approach to this problem includes manual intervention, which involves an individual shepherding each short work unit through the manufacturing process. This approach is labor intensive, involving analysis to select which work units can be released short, forcing a stop of the manufacturing process at the appropriate time on the individual work units and then matching the short work unit with the short parts when they become available. This highlights a need for a system whereby short work units are noted and matched with missing parts in a systematic way. The above labor-intensive approach is also prone to error, as work units can be accidentally overlooked. This approach is further time intensive, creating the potential for inadvertent shipments of incorrect products.

### BRIEF SUMMARY OF THE INVENTION

A method for managing production of a product when components of the product are missing during a manufacturing process is provided. The method includes applying a first set of rules for determining whether a short work unit can be released for manufacturing. The method further includes clearing the short work unit to build, responsive to determining that the short work unit can be released for manufacturing. The method further includes allocating for manufacturing a plurality of components of the short work unit that are present in inventory. The method further includes storing a record including a list of short components of the short work unit. The method further includes generating a first kit for the plurality of components of the short work unit that are present in inventory and storing a record including a location of the first kit. The method further includes initiating manufacturing of the plurality of components of the short work unit that are present in inventory. The method further includes determining that at least one of the short components of the short work unit are present in inventory. The method further includes generating a second kit for the at least one of the short components of the short work unit that are present in inventory.

A computer program product comprising a computer usable medium embodying computer usable program code for managing production of a product when components of the product are missing during a manufacturing process is further provided. The computer program product includes computer usable program code for applying a first set of rules for determining whether a short work unit can be released for manufacturing. The computer program product further includes computer usable program code for clearing the short work unit to build, responsive to determining that the short work unit can be released for manufacturing. The computer program product further includes computer usable program code for allocating for manufacturing a plurality of components of the short work unit that are present in inventory. The computer program product further includes computer usable program code for storing a record including a list of short components of the short work unit. The computer program product further includes computer usable program code for generating a first kit for the plurality of components of the short work unit that are present in inventory and storing a record including a location of the first kit. The computer program product further includes computer usable program code for initiating manufacturing of the plurality of components of the short work unit that are present in inventory. The computer program product further includes computer usable program code for determining that at least one of the short components of the short work unit are present in inventory. The computer program product further includes computer usable program code for generating a second kit for the at least one of the short components of the short work unit that are present in inventory.

A computer system for managing production of a product when components of the product are missing during a manufacturing process is further provided. The computer system includes a processor configured for applying a first set of rules for determining whether a short work unit can be released for manufacturing. The processor is further configured for clearing the short work unit to build, responsive to determining that the short work unit can be released for manufacturing. The processor is further configured for allocating for manufacturing a plurality of components of the short work unit that are present in inventory. The processor is further configured for storing a record including a list of short components of the short work unit. The processor is further configured for generating a first kit for the plurality of components of the short work unit that are present in inventory and storing a record including a location of the first kit. The processor is further configured for initiating manufacturing of the plurality of components of the short work unit that are present in inventory. The processor is further configured for determining that at least one of the short components of the short work unit are present in inventory. The processor is further configured for generating a second kit for the at least one of the short components of the short work unit that are present in inventory.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a conventional manufacturing process for a product;

FIG. 2 is an illustration of a manufacturing production network incorporating intelligent routing processing, according to one embodiment of the present invention;

FIG. 3 is a flow chart depicting a conventional process for managing short build work units; and

FIG. 4 is a flow chart depicting a general process for managing short build manufacturing, according to one embodiment of the present invention.

### DETAILED DESCRIPTION OF THE INVENTION

Embodiments of the present invention provide a method, system and computer program product for managing short work units during a manufacturing process. In accordance with an embodiment of the present invention, a method for managing production of a product when components of the product are missing during a manufacturing process is provided. The method includes applying a first set of rules for determining whether a short work unit can be released short for manufacturing. A priority level can be assigned to the product responsive to determining that the product can be released short for manufacturing. Then, manufacturing of the product is halted at a first point in the manufacturing process wherein the missing component is normally installed. When a subset of at least one of the missing components is in inventory, a second set of rules is applied for determining whether the at least one component is allocated to the short work unit based on the priority level of the order. Next, a kit is generated for the now allocated component(s), responsive to determining that the at least one component is allocated to the short work unit. The kitted component(s) is/are then routed to the first point for installation into the short work unit.

The present invention maximizes the manufacturing process by utilizing idle manufacturing resources and advancing a short build order as far through the manufacturing process as possible before halting and waiting for short components. The present invention further provides advanced visibility of halted work units, thereby allowing for easier routing of short components when they are made available. The present invention further improves the ability to prioritize the allocation of short parts as they come into a manufacturing process.

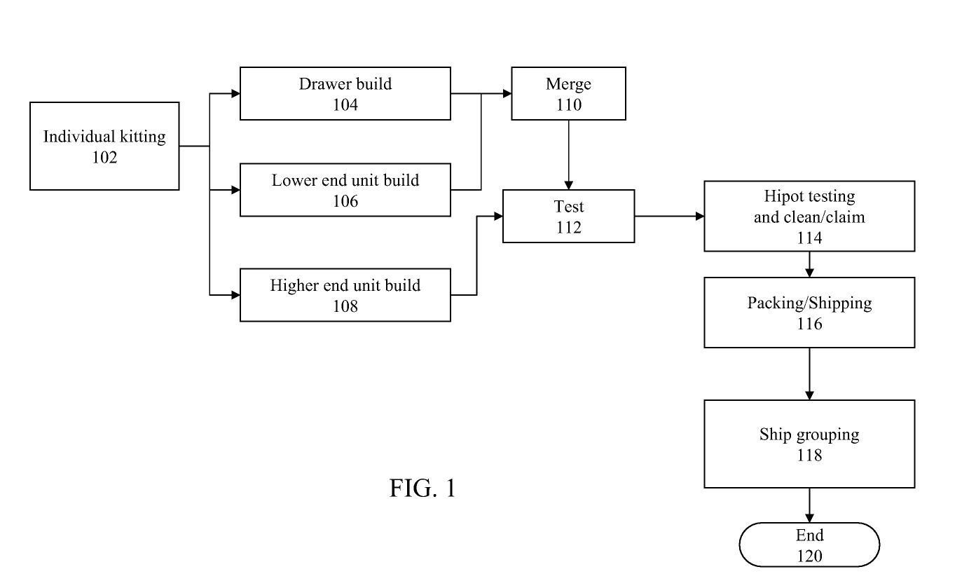

FIG. 1 is a block diagram illustrating a conventional manufacturing process for a product. In the embodiment of FIG. 1, the final product being manufactured is a multi-drawer rack mounted server system comprising multiple computer components. Each routing of the manufacturing process is represented by a block. A routing is defined as one or more manufacturing steps assembled together as a grouping. FIG. 1 is used to illustrate the various components of a manufacturing process, the production of multiple kits for various portions of the final product and the merging of kits during manufacturing.

Routing 102 comprises the kitting process that includes a procedure for acquiring a kit for each work unit in the product being manufactured. Each work unit begins with a kit that includes all of the components that comprise the work unit being manufactured. Routing 102 comprises the acquisition of each component necessary for manufacturing of the work units. From routing 102, three separate routings are spawned. The drawer unit is manufactured in routing 104, the lower end computer unit is manufactured in routing 106 and the higher end computer unit is manufactured in routing 108.

The output of routings 104 and 106 are merged in routing 110. Subsequently, the output of routings 110 and 108 are tested in routing 112. Next, the product undergoes high-potential testing and clean/claim procedures in routing 114. High-potential testing involves the testing of a unit for stray currents at high voltages. The clean/claim procedure involves the physical cleaning and quality assurance checking of the work unit.

In routing 116, the work unit undergoes a shipping process wherein the work unit is properly packed and prepared for shipping. In routing 118, a ship group is assembled, which includes the aggregation of the packed work unit and other items associated with the packed work unit, such as manuals, user's guides or other printed material. The manufacturing process of FIG. 1 ends in step 120.

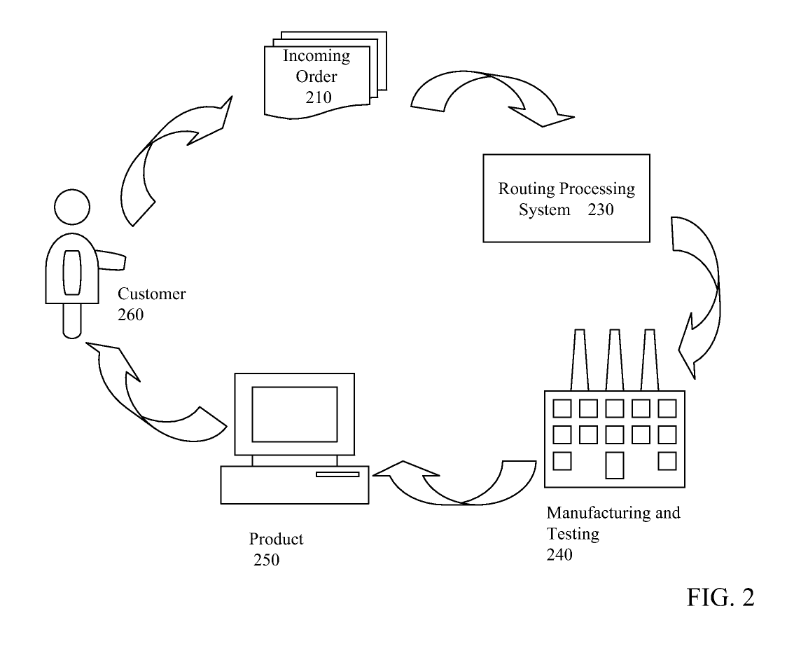

FIG. 2 is an illustration of a manufacturing production network incorporating intelligent routing processing, according to one embodiment of the present invention. The process depicted by FIG. 2 begins with a customer 260 placing an order 210 via a web site, telephone or mail. In advanced manufacturing environments where products are “configured to order” or “built to customer order,” an incoming order 210 can be processed by a routing processing system 230 wherein intelligent routing processing can be invoked to manage short build manufacturing. During intelligent routing processing 230, short builds can be released and resumed efficiently without losing manufacturing work. Thereafter, a produced product 250 can be passed through manufacturing and testing 240 and ultimately shipped to the customer 260.

In one embodiment of the present invention, a server including a processor performs the functions of the routing processing system 230. The server performs the automated steps for identifying work units for short build manufacturing, routing the work units accordingly and resuming manufacturing of the work units at predefined points in a mass production system.

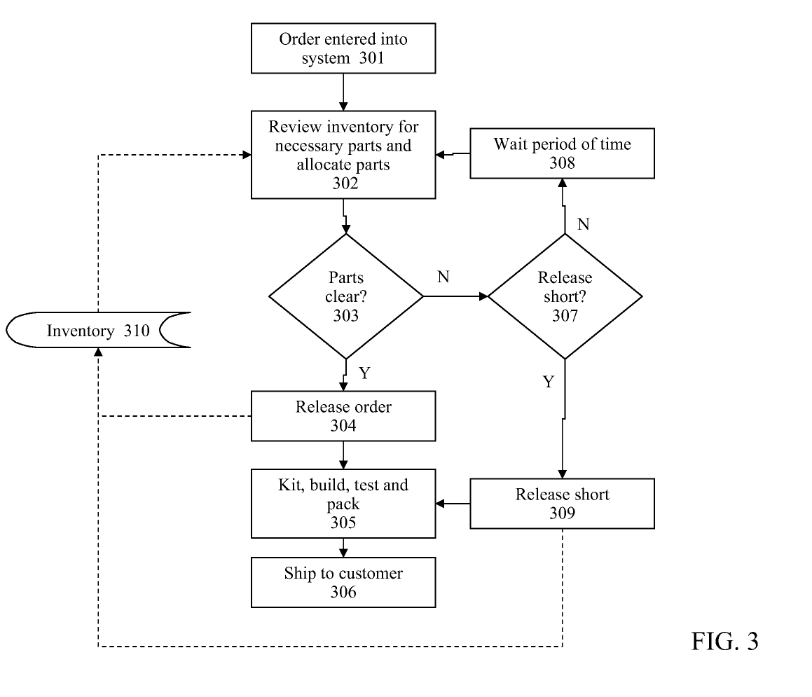

FIG. 3 is a flow chart depicting a conventional process for managing short build work units. The flow chart of FIG. 3 depicts a conventional process for querying an inventory for required parts of an incoming order, clearing orders (including short work units) to build, and allocating the required parts accordingly.

In a first step 301, an order is entered into an order processing system and further into a routing processing system such as system 230. Next, in step 302, the inventory database 310 is reviewed for the parts that are required to build the product of the incoming order. Further, the parts necessary for the product are allocated for installation in the product of the incoming order. In step 303, it is determined whether manufacturing should commence on the product, based on the results of the inquiry of step 302. The process of step 303 is also known as a “clear to build” query. If the result of the determination of step 303 is positive, then control flows to step 304. If the result of the determination of step 303 is negative, then control flows to step 307.

In step 304, the product of the incoming order is released for manufacturing and the inventory database 310 is modified to reflect this fact. In step 305, one or more kits for the product are prepared, and the product is built, tested and packed for shipping. In step 306, the product is shipped to the customer.

In step 307, it is determined whether the work unit can be released for manufacturing short (i.e., without having all required parts available), based on the results of the inquiry of step 302. If the result of the determination of step 307 is positive, then control flows to step 309. If the result of the determination of step 307 is negative, then control flows to step 308. In step 308, a period of time is allowed to lapse before control flows back to step 302, wherein the inventory database 310 is again reviewed for the parts that are required to build the product of the incoming order

In step 309, the product of the incoming order is released short for manufacturing and the inventory database 310 is modified to reflect this fact. Conventionally, after the work unit is shepherded through manufacturing as much as possible, the work unit is halted wherein it waits until the short parts become available. Then, an administrator or manufacturing floor worker must manually determine which work units require the short parts that become available, generate a kit for the short parts and find the work units needing the kit so as to route the kit to the appropriate work unit. Once the manufacturing of the work unit is complete, control flows from step 309 to step 305.

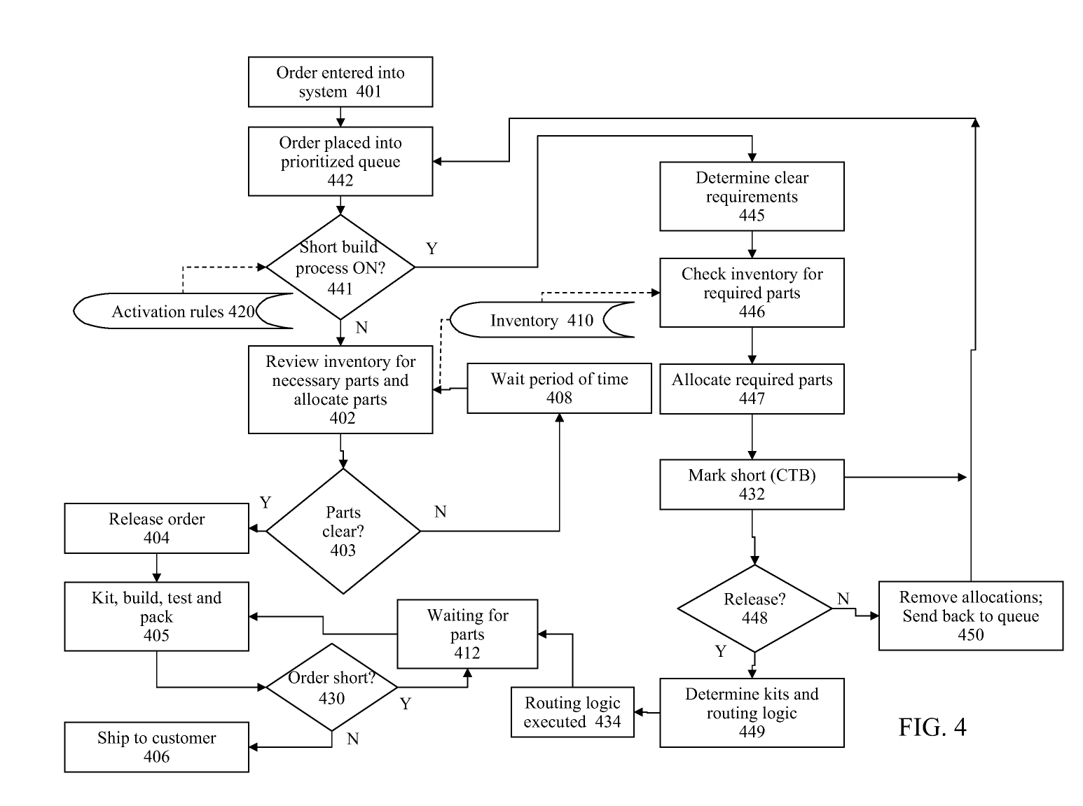

FIG. 4 is a flow chart depicting a general process for managing short build manufacturing, according to one embodiment of the present invention. The flow chart of FIG. 4 depicts a process similar to the process of FIG. 3 with the added feature of intelligent management of short build orders during the manufacturing process. The process of FIG. 4 may be executed by routing processing system 230.

In a first step 401, an order is entered into an order processing system and further into a routing processing system. In step 442, the incoming order is placed in a prioritization queue wherein each order is assigned a priority level. The prioritization queue is used to determine priority of work units or portions of work units (including short build kits) during the manufacturing process so as to decide how to allocate short parts when they become available. In this step, the incoming order (or a subset thereof) is placed in the queue according to its priority value such that orders with higher priority values are placed near the top of the queue and orders with lower priority values are placed near the bottom of the queue. In this way, the prioritization queue of step 442 allows for the prioritization of new incoming orders (or portions of orders), already existing orders (or portions or orders), and already existing short build kits all at once.

In step 441, it is determined whether the short build process will be used for the incoming order. If the result of the determination of step 441 is positive, then control flows to step 445. If the result of the determination of step 441 is negative, then control flows to step 402.

The determination of step 441 takes short build activation rules 420 into account. These rules define which products or work units can be short kitted. A rule is a list or set of statements about attributes of work units and/or attributes of orders for products. Attributes of a work unit may include a product name, a model number, a part number (work unit contains or does not contain a part number), a type, a location of production, a product line, a kit requirement and a current production status (such as started, un-started, at a particular routing, past a particular routing, etc.). Attributes of an order may include an order date, a shipment date, a build date, an order priority, a date window for a ship-by date, a compare to ship date, and an order type (such as domestic, international, server, etc.). A kit requirement attribute defines whether the entire order should be kitted, only the short work unit should be kitted or both. A compare to ship date defines the current number of days until the ship-by date.

In short, a rule is a set of statements that, if true, produce a match. That is, any work unit or order that meets the set of statements produces a match. In one embodiment of the present invention, a rule may list one or more attribute values that, if present in a work unit, produces a match. An attribute value may be specified in a positive manner, wherein the existence of the specified attribute value produces a match. For example, a statement that specifies a “model number=550” would produce a match with a work unit having a model number of 550. Alternatively, an attribute value may be specified in a negative manner, wherein the lack of the specified attribute value produces a match. For example, a statement that specifies a “model number=NOT 550” would produce a match with a work unit having a model number of 770. Further, attribute values may be specified in a range such that any attribute value that falls within that range produces a match. For example, a statement that specifies a “500<model number<700” would produce a match with a work unit having a model number of 600. Additionally, attribute values may be specified using a wildcard. For example, a hold criteria that specifies a “model number=6**” would produce a match with a work unit having a model number 655.

Next, in step 402, the inventory database 410 is reviewed for the parts that are required to build the product of the incoming order. Further, the parts necessary for the product are allocated for installation in the product of the incoming order. In step 403, it is determined whether manufacturing should commence on the product, based on the results of the inquiry of step 402. If the result of the determination of step 403 is positive, then control flows to step 404. If the result of the determination of step 403 is negative, then control flows to step 408. In step 408, a period of time is allowed to lapse before control flows back to step 402, wherein the inventory database 410 is again reviewed for the parts that are required to build the product of the incoming order.

In step 404, the product of the incoming order is released for manufacturing and the inventory database 410 is modified to reflect this fact. In step 405, one or more kits for the product are prepared, and the product is built, tested and packed for shipping. If the order is still short in step 430, then control flows to step 412. Otherwise, control flows to step 406, where the product is shipped to the customer. In step 412, the process waits for the parts that are missing from the order deemed short in step 430.

In step 445, the requirements for clearing the order for manufacturing are determined. This step results in the generation of a list of parts that are absolutely required for an order, or kit, to be released, and a list of parts that are acceptable to be short when the order, or kit, is released. In one embodiment of the present invention, the determination of step 445 further takes short build execution rules into account. Short build execution rules define which products or work units should be short kitted according to certain operational conditions or other factors. For example, product numbers and product types can be taken into account. Short build execution rules can further define whether the determination of short build execution is fully automatic or requires approval from an administrator. Further, short build execution rules can define whether single kitting shall occur or multiple kitting.

In step 446, the inventory database 410 is checked for availability of the required parts for the incoming order. Thus, the lists prepared in step 445 are compared to the parts available in inventory database 410. In step 447, the required parts found in the inventory database 410 are allocated to the manufacturing of the incoming order. The functions of step 447 may occur automatically or may require the approval of an administrator. In one embodiment of the present invention, the determination of step 447 further takes short build execution rules into account. In step 432, the unallocated parts of the order are marked as short and the order or subset of the order is sent to the prioritization queue in step 442 so as to be placed in the proper place in the queue according to priority. Concurrently, controls flows to step 448, wherein it is determined whether the incoming order (or a subset thereof) shall be released short in a controlled manner. That is, it is determined whether the order shall be released to build in a short mode while waiting for short parts in step 412.

If the result of the determination of step 448 is positive, then control flows to step 449. If the result of the determination of step 448 is negative, then control flows to step 450. The determination of step 448 may take various factors into account, such as the priority level of the incoming order, as specified in step 442, and the information present in the rules 420. The determination of step 448 may further take into account the following factors: revenue, capacity and cycle time.

In step 450, the incoming order is ordered not to be released and therefore the allocations of step 447 are removed and the order is sent back to the prioritization queue for reevaluation under step 442. Furthermore, any parts previously marked short in step 432 remain marked short. In step 449, the generation of the proper kit or kits for the incoming order is determined, as well as the routing logic for the kits during the manufacturing process. This includes the locations of the kits and locations of any merges on the manufacturing floor. Further, in step 449, multiple kits can be generated for multiple short parts that must later be merged with the primary work unit. The determination of step 449 may take various factors into account, such as the information specified in the rules 420. In step 434, the routing logic determined in step 449 is executed, such that the kit is moved to the correct location on the manufacturing floor.

In one embodiment of the present invention, the determination of step 449 further takes kit merge control rules into account. Kit merge control rules define the routing logic for short build kits since the primary work units are already located at a particular point in the manufacturing process. For example, product numbers and product lines can be defined in a kit merge control rule. Further, the following attributes can be defined in a kit merge control rule: operational conditions, whether to combine the short build kit with another kit, the location of the merge of short build kit with another kit, the default location of the primary work unit and to whom an email notification shall be made. Thus, a newly available short part can be placed in the correct kit using the routing logic data available in a kit merge control rule.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for managing production of a product when components of the product are missing during a manufacturing process, comprising:
applying a first set of rules for determining whether a short work unit can be released for manufacturing;
clearing the short work unit to build, responsive to determining that the short work unit can be released for manufacturing;
allocating for manufacturing a plurality of components of the short work unit that are present in inventory;
storing a record including a list of short components of the short work unit;
generating a first kit for the plurality of components of the short work unit that are present in inventory and storing a record including a location of the first kit;
initiating manufacturing of the plurality of components of the short work unit that are present in inventory;
determining that at least one of the short components of the short work unit are present in inventory; and
generating a second kit for the at least one of the short components of the short work unit that are present in inventory.

2. The method of claim 1, further comprising:
transferring the second kit to the location of the first kit.

3. The method of claim 2, further comprising:
initiating manufacturing of the at least one of the short components of the short work unit.

4. The method of claim 3, further comprising:
determining that at least one of the short components of the short work unit are present in inventory; and
generating a third kit for the at least one of the short components of the short work unit that are present in inventory.

5. The method of claim 4, further comprising:
transferring the third kit to the location of the first kit; and
initiating manufacturing of the at least one of the short components of the short work unit.

6. The method of claim 3, wherein the step of applying a first set of rules comprises:
comparing attributes defined in a first set of rules with attributes of the short work unit.

7. A computer program product comprising a computer usable medium embodying computer usable program code for managing production of a product when components of the product are missing during a manufacturing process comprising:
computer usable program code for applying a first set of rules for determining whether a short work unit can be released for manufacturing;
computer usable program code for clearing the short work unit to build, responsive to determining that the short work unit can be released for manufacturing;
computer usable program code for allocating for manufacturing a plurality of components of the short work unit that are present in inventory;
computer usable program code for storing a record including a list of short components of the short work unit;
computer usable program code for generating a first kit for the plurality of components of the short work unit that are present in inventory and storing a record including a location of the first kit;
computer usable program code for initiating manufacturing of the plurality of components of the short work unit that are present in inventory;
computer usable program code for determining that at least one of the short components of the short work unit are present in inventory; and
computer usable program code for generating a second kit for the at least one of the short components of the short work unit that are present in inventory.

8. The computer program product of claim 7, further comprising:
computer usable program code for transferring the second kit to the location of the first kit.

9. The computer program product of claim 8, further comprising:
computer usable program code for initiating manufacturing of the at least one of the short components of the short work unit.

10. The computer program product of claim 9, further comprising:
computer usable program code for determining that at least one of the short components of the short work unit are present in inventory; and
computer usable program code for generating a third kit for the at least one of the short components of the short work unit that are present in inventory.

11. The computer program product of claim 10, further comprising:
computer usable program code for transferring the third kit to the location of the first kit; and
computer usable program code for initiating manufacturing of the at least one of the short components of the short work unit.

12. The computer program product of claim 11, wherein the computer usable program code for applying a first set of rules comprises:
computer usable program code for comparing attributes defined in a first set of rules with attributes of the short work unit.

13. A computer system for managing production of a product when components of the product are missing during a manufacturing process, comprising:
a processor configured for:
applying a first set of rules for determining whether a short work unit can be released for manufacturing;
clearing the short work unit to build, responsive to determining that the short work unit can be released for manufacturing;
allocating for manufacturing a plurality of components of the short work unit that are present in inventory;
storing a record including a list of short components of the short work unit;
generating a first kit for the plurality of components of the short work unit that are present in inventory and storing a record including a location of the first kit;
initiating manufacturing of the plurality of components of the short work unit that are present in inventory;
determining that at least one of the short components of the short work unit are present in inventory; and
generating a second kit for the at least one of the short components of the short work unit that are present in inventory.
